(19) United States
(12) Patent Application Publication
(10) Pub. No.: US 2025/0290016 A1
(43) Pub. Date: Sep. 18, 2025

(54) APPARATUS AND METHOD OF MIXING AND AGING LIQUIDS AND ALCOHOLIC BEVERAGES

(71) Applicant: Brian H. Hamilton, Charlotte, NC (US)

(72) Inventor: Brian H. Hamilton, Charlotte, NC (US)

(21) Appl. No.: 19/078,175

(22) Filed: Mar. 12, 2025

Related U.S. Application Data
(60) Provisional application No. 63/564,206, filed on Mar. 12, 2024.

(51) Int. Cl. C12G 3/07; B01F 33/452; B01F 35/222; B01F 35/32; B01F 101/16; C12H 1/22

(52) U.S. Cl. CPC C12G 3/07; B01F 33/452; B01F 35/222; B01F 35/3204; C12H 1/22; B01F 2101/16

(57) ABSTRACT

A system for processing a liquid inside a container includes an external magnet positioned outside the container and sufficiently proximate to the container to direct a magnetic field into the container. An internal magnet positioned inside the container is within the magnetic field of the external magnet. An automated shaft is connected to the external magnet and is configured to rotate the external magnet and induce a corresponding rotation of the internal magnet. At least one baffle is connected to the internal magnet and rotating within the liquid with the corresponding rotation of the internal magnet.

### CROSS REFERENCE TO RELATED APPLICATIONS

This application claims priority to U.S. Provisional Patent Application Ser. No. 63/564,206 filed on Mar. 12, 2024, entitled Apparatus and Methods of Aging Alcoholic Beverages, which is incorporated by reference in its entirety.

### FIELD

This disclosure relates to the field of storing, mixing, and aging liquids in a container, including but not limited to aging alcoholic beverages stored and aged in wooden barrels.

### BACKGROUND

Alcoholic beverages, such as wine and spirits, are often aged in containers such as wooden barrels. The barrels are often stored in a horizontal orientation on the belly of the barrel around its largest circumference and must be physically turned and rotated to mix the liquid and to provide the liquid alcoholic beverage with maximum exposure to the flavors and chemical profile of the wooden barrels. A need exists in the art liquid processing and manufacturing for ways to mix liquids with less manual labor, and additional needs arise in the context of alcoholic beverage aging which would benefit from a new way to mix and age the alcoholic beverages.

### SUMMARY

This disclosure includes systems and methods of storing liquids in a container, such as a wooden barrel, and allowing the liquid to be infiltrated with flavors and/or chemical compositions from the structure of the container. One example embodiment is a way of aging alcoholic beverages in a wooden barrel and increasing a surface area of contact between the liquid and the wood of the barrel. The increased surface area can accelerate the aging and flavoring process, and by moving baffle structures within the barrel, the mixing occurs without physical rotation of the container or barrel. In this way the barrels can be stored upright. Upright storage allows for better use of storage space and better accessibility to the barrels for testing.

In one embodiment, a system for processing a liquid inside a container includes an external magnet positioned outside the container and sufficiently proximate to the container to direct a magnetic field into the container. An internal magnet positioned inside the container is within the magnetic field of the external magnet. An automated shaft is connected to the external magnet and is configured to rotate the external magnet and induce a corresponding rotation of the internal magnet. At least one baffle is connected to the internal magnet and rotating within the liquid with the corresponding rotation of the internal magnet.

### BRIEF DESCRIPTION OF THE DRAWINGS

The accompanying drawings, which are in and constitute a part of this specification, illustrate certain examples of the present disclosure and together with the description, serve to explain, without limitation, the principles of the disclosure. Like numbers represent the same element(s) throughout the figures.

FIG. 1 is cross section view of a container for a liquid with magnetics and baffles according to this disclosure.

FIG. 2 is an exploded view of a baffle assembly according to this disclosure.

FIG. 3 is an exploded view of an inner housing for a magnet or internal rotating device such as a plate inside a barrel and corresponding to an external magnet assembly according to this disclosure.

FIG. 4 is a view of an external magnetic rotation device according to this disclosure.

FIG. 5 is a view of an internal housing for either a magnet or a conductive plate used as an internal rotating device according to this disclosure.

### DETAILED DESCRIPTION

The following description of the disclosure is provided as an enabling teaching of the disclosure in its best, currently known embodiment(s). To this end, those skilled in the relevant art will recognize and appreciate that many changes can be made to the various embodiments described herein, while still obtaining the beneficial results of the present disclosure. It will also be apparent that some of the desired benefits of the present disclosure can be obtained by selecting some of the features of the present disclosure without utilizing other features. Accordingly, those who work in the relevant arts will recognize that many modifications and adaptations to the present disclosure are possible and can even be desirable in certain circumstances and are a part of the present disclosure. Thus, the following description is provided as being illustrative of the principles of the present disclosure and not in limitation thereof.

This disclosure makes use of an overall principle of electromagnetics in a new way to develop advancements in storing, mixing and aging liquids, such as, but not limited to, alcoholic beverages. This disclosure may have usefulness in aging alcoholic beverages in barrels and other containers that impart flavors to the beverage (or provide other chemical adjustments to any liquid) by placing the beverage into contact with internal walls of the container, mixing the beverage or liquid within the container, and maximizing contact with the walls of the container through all portions of the liquid. This disclosure could also be adapted to mixing any kind of liquid in a container, even if additives are placed within the liquid for mixing before storage in the container or after being stored in the container. This disclosure encompasses structures that are typically used as containers, such as barrels of all kinds, including but not limited to wooden barrels that are used to age and flavor beer, wine and alcoholic spirits. The containers may include taps and openings as necessary to access the liquids within the container for dispensing or other processing.

As noted, the containers and barrels of this disclosure make use of electromagnetics to impart rotations and mixing activity to liquids within a container. Proximity of an external rotating magnet to an internal rotating device (relative to an interior of the container) creates an electromagnetic field between the external rotating magnet and the internal rotating device and may even induce eddy currents on the internal rotating device. When the external rotating magnet rotates, it induces electromagnetic energy onto the internal rotating device. Dissipation of that energy leads to movement of the internal rotating device. The internal rotating device may rotate with the external rotating magnet (i.e., for instances in which the internal rotating device houses an attracted, properly polarized magnet), or the internal rotating device may develop eddy currents (i.e., where the internal rotating device houses a conductive plate). The eddy currents in the internal rotating device induce an opposite magnetic field that tends to work against the external rotating magnet and its corresponding electromagnetic field. The eddy currents and/or forces of magnetic attraction, therefore, cause an energy imbalance within the respective magnetic fields, and also induce motion of the internal rotating device. Similar physical reactions occur when the internal rotating device is an internal magnet that is attracted to the external rotating magnet in alternating cycles, such as with an electromagnet controlled with an electronic power signal.

As an overview, the internal rotating device may be connected to baffles that turn with the internal rotating device. The internal rotating device inside the container is completely sealed off from the external rotating magnet except for communication of respective electromagnetic fields through the container structure. In this way, the system can be entirely closed so as to not allow for undesirable exposure of the liquid to the ambient environment or metal parts or magnets, yet still allow for mechanical motion inside the container.

The claims below and the attached figures further expand this functional description.

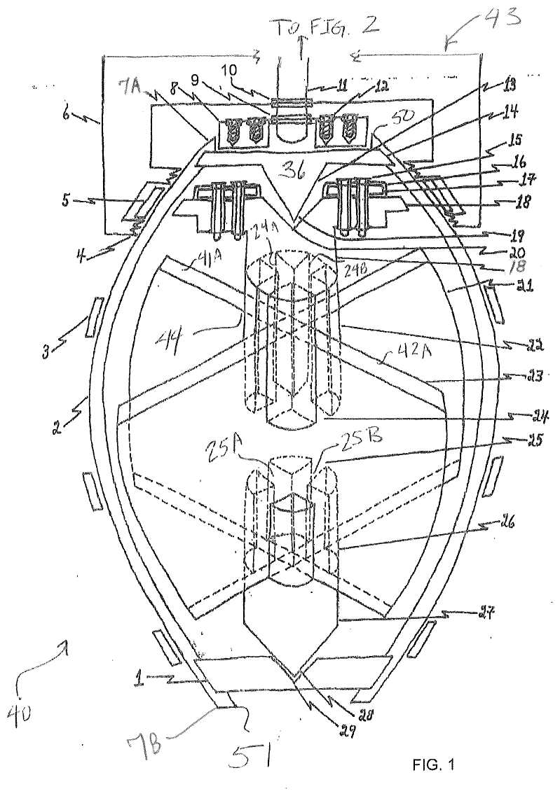

FIG. 1 presents an overview of an apparatus and system that may be used with an associated method of mixing liquids within a container, using electromagnetic physical properties of an external rotating magnet outside of the container and an internal rotating device that is internal to the container. The respective rotating magnet and rotating device impart motion to baffles within the container, wherein the baffles are structured to impart not only mixing motions to the liquid but, in non-limiting embodiments, the baffles can increase the surface area of interior walls of the container in contact with the liquid to impart flavor and/or chemical composition updates by surface contact, absorption, or adhesion.

FIG. 1 is only shown as an example of a container 40 that is used to house and mix liquids, such as alcoholic beverages, inside the container 40. The container may have numerous kinds of structural features and still remain within the scope of this disclosure, so long as the container is configured to utilize electromagnetic forces to initiate mixing motions, including but not limited to rotations, or even plunging, vibrating, shaking, and tilting motions applied within the liquid for mixing and/or contacting with walls and other structures inside the container. In some embodiments, the disclosure includes chemically changing the liquid through contact with structures and walls inside the container.

One non-limiting example of the concepts shown herein lies in using a wooden barrel as an example of a container 40. A wooden barrel is often used to store, age, and impart flavor to alcoholic beverages, such as spirits and wine stored in oak barrels, or even charred and smoked oak barrels, for a particular chemical composition and flavor profile imparted to the liquid by contact with the inside walls of the wood in the barrel. A wooden barrel, therefore, is discussed herein as one non-limiting example of this disclosure.

So far as an overall construction is concerned, the wooden barrel used as a container 40 of this disclosure may be constructed in numerous ways so long as the wooden interior is in contact with the liquid. Accordingly, FIG. 1 shows the barrel as a compilation of staves 2 extending side-by-side around respective circumferences of a first end 50 and a second end 51 of the barrel 40, which may include a standard lip or chime 7A forming a ridge within which a lid or top cap 36 may connect to the staves at one end and a bottom cap 1 attaches to bottom edges of the staves or an additional chime 7B at another end. Various hoops 3, 5 are often used to hold the staves 2 in a barrel shape to form an open area within the barrel for holding the liquid to be mixed inside the container 40.

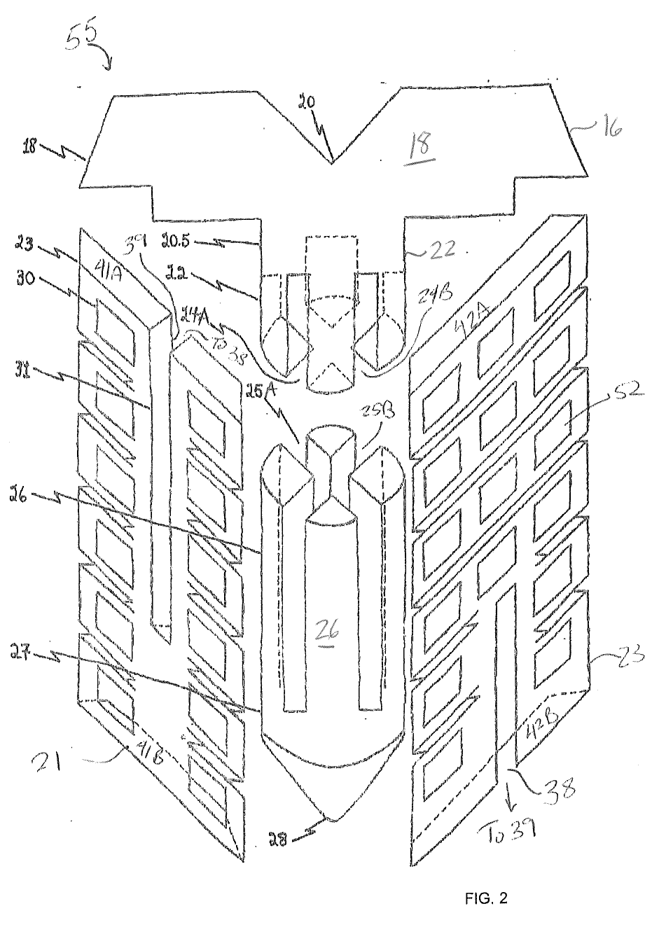

FIGS. 1 and 2 illustrate overview components of an apparatus and system of this disclosure and are discussed from the perspective of modular components that fit together in example implementations. For example, one kind of mixing tool that may be used in conjunction with containers 40 of this disclosure are baffles 21, 23 that not only fit together as shown by the directional annotations of FIG. 2, but also fit within spaces 24A, 24B and 25A, 25B of a respective first shaft 22 and second shaft 26. In other words, as shown in FIG. 2, the baffles mate by sliding an open portion 39 of a first baffle 21 into a mating opening 38 of a second baffle 23 to form single, cross-shaped baffle structure 44 shown in FIG. 1. FIG. 2 further shows how top edges 41A, 42A of the respective baffles 21, 23 slide into respective slots or spaces 24A, 24B of the first shaft 22. Bottom edges 41B, 42B of the respective baffles 21, 23 in FIG. 2 slide into additional slots or additional spaces 25A, 25B of the second shaft 26. The described configuration, therefore, secures the baffles 21, 23 to each other and to respective first and second shafts 22, 26 at the top and bottom (i.e., first end 50 and second end 51) of the container 40.

The respective first shaft 22 and second shaft 26 are portions of an internal assembly 55 that is modular/separable and configured for placing inside the container 40, and the internal assembly 55 of FIG. 2 that has particular structural aspects of its own. For example, the first shaft 22 may be a separable or an integral portion of a support plate 18 that holds an internal rotating device 17 in place at a first end 50 of the container 40 as shown in FIG. 1. In some embodiments, the internal rotating device 17 may be another magnet or a conductive plate or ring that is encased within a barrier structure 16 to separate the internal rotating device 17 from liquid within the container 40. As shown in FIG. 1 and FIG. 2, the support plate 18, the barrier structure 16, and the internal rotating device 17 may be held together by means that are available such as plugs 15 of any type (e.g., wood, stainless steel, or other materials that do not hinder any goals of the mixing in regard to flavor or chemical compositions).

The support plate 18 may include a notch-shaped surface 20 that defines a space in which the support plate 18 has a rotational degree of freedom when placed in contact with a top cap 36 shown in FIG. 1 at the first end 50 of the container 40. The top cap 36 includes a first pivot point tip 19 that fits within the notch-shaped surface 20 with sufficient space therein to serve as a guide for the support plate 18 without hindering movement, whether by floating or spinning, of the support plate 18 within the container 40. As can be seen in the figures, spinning of the internal rotating device 17, due to electromagnetic properties discussed above, imparts corresponding motion on the connected support plate 18 and the further connected baffles 21, 23. In other words, the electromagnetic field between the external magnet 8 of FIG. 1 and the internal rotating device 17 of FIG. 1 can induce movement of the baffles 21, 23 inside the container 40 with the container being an entirely closed system, so long as the materials of construction are permeable to electromagnetism. In this sense, the external magnet 8 and the internal rotating device 17 are in electromagnetic field communication through the container 40 and its internal parts 16, 17, 18.

The second end 51 of the container includes a bottom cap 1 that has a similar assembly with a second pivot point tip 28 fitting with a rotational degree of freedom in a bottom notch-shaped surface 29 of the bottom cap 1. Both shafts 22, 26, therefore, impart and allow for motion, particularly rotational motion, of the baffles 21, 23 of this disclosure for mixing the liquid in the container 40. The first pivot point tip 19 and the second pivot point tip 28 may be used to keep the baffles 21, 23 aligned within the container without floating in the liquid to one side or the other, i.e., the guiding maintains smooth rotation of the baffles without side wall obstruction. The baffles can rotate but not float off in any direction.

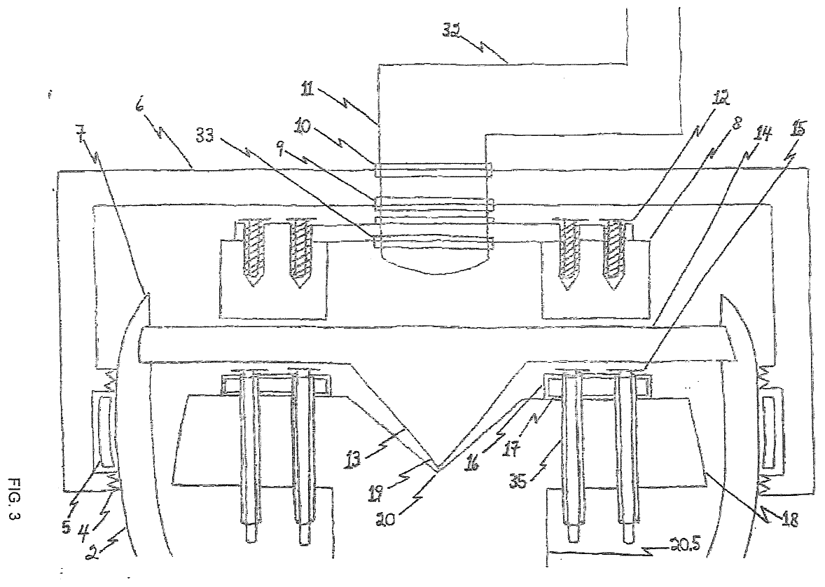

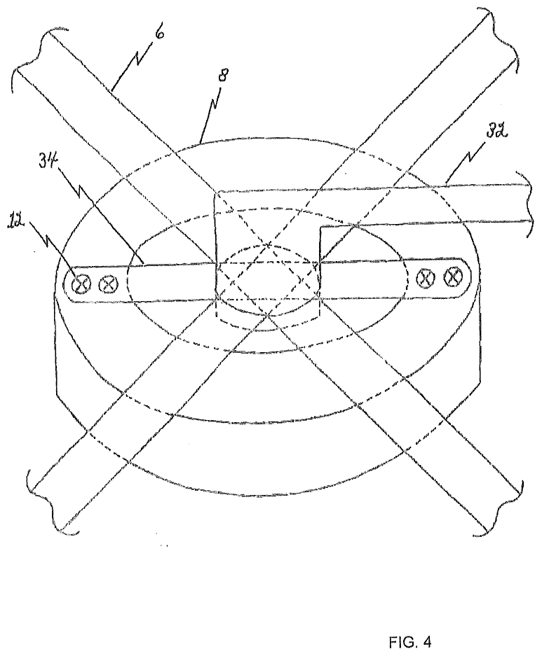

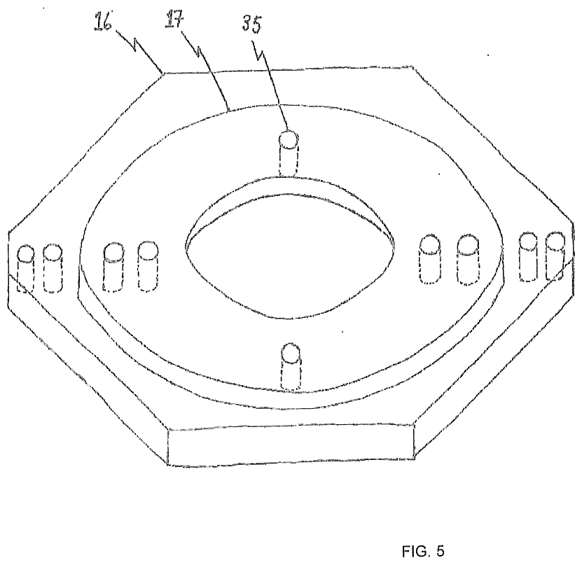

The system and apparatus of this disclosure discussed so far shows that the container 40 may be sealed in all dimensions when liquid is contained therein. The internal rotating device 17 is configured to rotate upon the force of electromagnetic fields imparted from outside the sealed container so that no electrically powered or manually rotated mixing components are required inside the container 40. The above-described magnetic motion or motion induced by eddy currents depends on whether the internal rotating device 17 is a respective magnet or an electrical conductor, and in either assembly, the internal rotating device 17, is subject to the electromagnetic properties of an exterior structure 43 that can be positioned proximately to the container 40 and induce the desired mixing from entirely outside the container. In one example shown in FIGS. 1-3, the exterior structure 43 is connected by armature and brace assemblies 6, 32, 34 to an exterior magnet 8 that can be induced to rotate by any power source connected to a rotation arm 32. The spinning of the exterior magnet 8 as part of the exterior structure 43 shown in FIG. 4 can induce corresponding electromagnetic responses in the internal rotating device 17 as described above. The exterior structure 43 may be positioned in any place that allows it to provide electromagnetic fields to the internal rotating device 17. In the example of FIG. 3, the exterior structure grips the exterior of the container by teeth 4 but other attachment devices are within the scope of this disclosure. The internal rotating device can be seen in its plan view at FIG. 5 as being connected to its barrier structure 16 by various devices 35 holding the internal rotating device in place and connected to the support structure 18.

This disclosure is particularly adept at increasing surface area of the mixing components beyond just the walls of the container. As shown in the figures, the baffles and associated construction may be made of wood or other preferred materials to impart the same flavor that barrel walls have traditionally provided. The baffles may include openings 52 that increase the surface area exposed to the liquid as shown in FIG. 2. It is within the scope of this disclosure for the exterior structure 43, holding the exterior magnet 8 and the top cap 36, the barrier structure 16, and associated structures to be made of materials that allow the electromagnetic fields from the exterior magnet 8 to reach the internal rotating device 17.

Unless defined otherwise, all technical and scientific terms used herein have the same meaning as commonly understood to one of ordinary skill in the art to which this disclosure belongs.

As used in the specification and claims, the singular form “a,” “an,” and “the” include plural references unless the context clearly dictates otherwise. For example, the term “an agent” includes a plurality of agents, including mixtures thereof.

As used herein, the terms “can,” “may,” “optionally,” “can optionally,” and “may optionally” are used interchangeably and are meant to include cases in which the condition occurs as well as cases in which the condition does not occur. Thus, for example, the statement that a formulation “may include an excipient” is meant to include cases in which the formulation includes an excipient as well as cases in which the formulation does not include an excipient.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed.

It is also important to note that the construction and arrangement of the elements of the system as shown in the preferred and other exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability. Accordingly, all such modifications are intended to be included within the scope of the present disclosure. The order or sequence of any process or method steps may be varied or re-sequenced according to alternative embodiments. Other substitutions, modifications, changes and omissions may be made in the design, operating conditions and arrangement of the preferred and other exemplary embodiments without departing from the spirit of the present subject matter.

It should be understood that while the present disclosure has been provided in detail with respect to certain illustrative and specific aspects thereof, it should not be considered limited to such, as numerous modifications are possible without departing from the broad spirit and scope of the present disclosure as defined in the appended claims. It is, therefore, intended that the appended claims cover all such equivalent variations as fall within the true spirit and scope of the embodiments claimed herein.

Although exemplary implementations may refer to utilizing aspects of the presently disclosed subject matter in the context of one or more stand-alone computer systems, the subject matter is not so limited, but rather may be implemented in connection with any computing environment or other distributed computing environments. Still further, aspects of the presently disclosed subject matter may be implemented in or across a plurality of processing chips or devices, and storage may similarly be implemented across a plurality of devices. Such devices might include personal computers, network servers, and handheld devices, for example.

Embodiments of FIGS. 1-5 may be summarized as follows:

A system for processing a liquid inside a container includes:
an external magnet positioned outside the container and sufficiently proximate to the container to direct a magnetic field into the container;
an internal magnet positioned inside the container within the magnetic field of the external magnet;
an automated shaft connected to the external magnet and configured to rotate the external magnet and induce a corresponding rotation of the internal magnet;
at least one baffle connected to the internal magnet and rotating within the liquid with the corresponding rotation of the internal magnet.

The liquid may be an alcoholic beverage.

The alcoholic beverage may be a wine or a spirit.

The container may be a barrel for aging the wine or the spirit.

The baffle may be a material that adjusts a quality of the liquid, wherein the quality is selected from the group consisting of aroma, taste, flavor, color, viscosity, and chemical composition.

The baffle may be made of wood.

The baffle may define openings that increase a surface area of the baffle in contact with the liquid.

An internal rotating device may be an internal magnet positioned inside a portion of an internal housing, and the baffle connects to the housing.

The internal housing and the baffle may be configured to float in the liquid.

A cap on the container may have an inner surface and an outer surface, wherein the inner surface of the cap includes an edge on a surface that mates with the internal housing of the internal rotating device such as an internal magnet or internal conductor in the form of a plate, with the mating allowing rotational degrees of freedom for the internal housing.

Another embodiment may by a system for processing a liquid inside a container having an external magnet positioned outside the container and sufficiently proximate to the container to direct an external magnetic field into the container, and the system includes:
an internal plate positioned inside the container within the external magnetic field of the external magnet, wherein the internal plate comprises a conductor;
an automated shaft connected to the external magnet and configured to rotate the external magnet and induce an electrical field and an opposing magnetic field around the internal plate,
wherein the opposing magnetic field moves the internal plate within the liquid;
at least one baffle connected to the internal plate and moves within the liquid with corresponding movement of the internal plate.

The internal plate may be a conductive copper plate.

Corresponding movement of the internal plate may be rotational movement.

Corresponding movement of the internal plate may be a vertical translation, a horizontal translation, or an angled translation of the internal plate and the at least one baffle.

The liquid in the container may be an alcoholic beverage.

The alcoholic beverage may be beer, wine or a spirit.

The container may be a barrel for aging the wine or the spirit.

The baffle may be a material that adjusts a quality of the liquid, wherein the quality is selected from the group consisting of aroma, taste, flavor, color, viscosity, and chemical composition.

The system may include the baffle being made of wood.

The baffle defines openings that increase a surface area of the baffle in contact with the liquid.

The internal plate is positioned inside a portion of an internal housing, and the baffle connects to the housing.

The internal housing and the baffle are configured to float in the liquid.

A cap on the container may include an inner surface and an outer surface, wherein the inner surface of the cap comprises an edge that mates with the internal housing of the internal magnet.

Another embodiment of the disclosure is a system for processing a liquid inside a container, including
an external magnet positioned outside the container and sufficiently proximate to the container to direct an external magnetic field into the container;
an internal plate positioned within an internal housing inside the container and within the external magnetic field of the external magnet, wherein the internal plate comprises a conductor;
an automated shaft connected to the external magnet and configured to rotate the external magnet and induce an electrical field and an opposing magnetic field around the internal plate,
wherein the opposing magnetic field moves the internal plate within the liquid;
at least one baffle connected to the internal plate and moves within the liquid with corresponding movement of the internal plate.

The electrical field and the opposing magnetic field correspond to eddy currents on the internal plate induced by the external magnetic field in the container.

At least one baffle includes a first baffle and a second baffle that mates with the first baffle.

The system may include a cap on the container and a bottom enclosure on the container, wherein the cap and the bottom enclosure each comprise respective inner surfaces and outer surfaces, wherein the inner surface of the cap comprises an edge that mates with the internal housing of the internal plate, and the inner surface of the bottom enclosure mates with second baffle, wherein the inner housing, the first baffle, and the second baffle are secured against vertical movement within the container.

The system may include a cap on the container and a bottom enclosure on the container, wherein the cap and the bottom enclosure each have respective inner surfaces and outer surfaces, wherein the inner surface of the bottom enclosure comprises a bottom edge that mates with the internal housing of the internal plate, and the inner surface of the cap mates with the second baffle, wherein the inner housing, the first baffle, and the second baffle are secured against vertical movement within the container.

The system may include an internal plate having a conductive copper plate.

Corresponding movement of the internal plate is rotational movement

Corresponding movement of the internal plate is a vertical translation, a horizontal translation, or an angled translation of the internal plate and the at least one baffle.

The liquid may be an alcoholic beverage.

The alcoholic beverage comprises wine or a spirit.

The container is a barrel for aging the wine or the spirit.

The baffle may include a material that adjusts a quality of the liquid, wherein the quality is selected from the group consisting of aroma, taste, flavor, color, viscosity, and chemical composition.

The baffle is made of wood.

The baffle defines openings that increase a surface area of the baffle in contact with the liquid.

The internal plate is positioned inside a portion of an internal housing, and the baffle connects to the housing.

The internal housing and the baffle are configured to float in the liquid.

The container defines and inlet opening and/or an outlet opening for filling the container and dispensing liquid from the container.

Another embodiment is a modular system for processing a liquid inside a container, including:
an external magnet positioned outside the container and sufficiently proximate to the container to direct an external magnetic field into the container;
an internal plate positioned within an internal housing inside the container and within the external magnetic field of the external magnet, wherein the internal plate comprises either a second magnet or a conductive plate;
an automated shaft connected to the external magnet and configured to rotate the external magnet and induce an electrical field and/or a magnetic field around the internal housing,
wherein the electrical field or the magnetic field moves the internal housing within the liquid;
a first baffle connected to the internal housing and exhibiting movement within the liquid with corresponding movement of the internal housing;
a second baffle connected to the first baffle and a second baffle support and exhibiting additional movement within the liquid with the corresponding movement of the internal housing;
a cap on the container, wherein the cap comprises an inner surface and an outer surface, wherein the inner surface of the cap comprises an edge that mates with the internal housing of the internal magnet; and
a bottom enclosure on the container, wherein the bottom enclosure comprises a respective inner surface that mates with the second baffle support.

The internal housing is configured to mate with the bottom enclosure instead of the cap, and the second baffle support is configured to mate with the cap instead of the bottom enclosure.

The modular housing may include at least one outlet for incoming and outgoing liquid relative to the container.

The container, the inner housing, the first baffle, and the second baffle are collectively a closed system that is mechanically isolated from the external magnet.

The modular system may include an electronic controller connected to the automated shaft to allow for power control in rotating the external magnet.

A motor may be connected to the automated shaft and in electrical communication with the controller.

Additional details of this disclosure supported in the claims below and the associated figures.

1. A system for processing a liquid inside a container, comprising:
an external magnet positioned outside the container and sufficiently proximate to the container to direct a magnetic field into the container;
an internal magnet positioned inside the container within the magnetic field of the external magnet;
an automated shaft connected to the external magnet and configured to rotate the external magnet and induce a corresponding rotation of the internal magnet;
at least one baffle connected to the internal magnet and rotating within the liquid with the corresponding rotation of the internal magnet.

2. The system of claim 1, wherein the liquid is an alcoholic beverage.

3. The system of claim 2, wherein the alcoholic beverage comprises wine or a spirit.

4. The system of claim 3, wherein the container is a barrel for aging the wine or the spirit.

5. The system of claim 1, wherein the baffle comprises a material that adjusts a quality of the liquid, wherein the quality is selected from the group consisting of aroma, taste, flavor, color, viscosity, and chemical composition.

6. The system of claim 5, wherein the baffle is made of wood.

7. The system of claim 5, wherein the baffle defines openings that increase a surface area of the baffle in contact with the liquid.

8. The system of claim 1, wherein the internal magnet is positioned inside a portion of an internal housing, and the baffle connects to the housing.

9. The system of claim 8, wherein the internal housing and the baffle are configured to float in the liquid.

10. The system of claim 9, further comprising a cap on the container, wherein the cap comprises an inner surface and an outer surface, wherein the inner surface of the cap comprises an edge that mates with the internal housing of the internal magnet.

11. A modular system for processing a liquid inside a container, comprising:
an external magnet positioned outside the container and sufficiently proximate to the container to direct an external magnetic field into the container;
an internal rotating device positioned within an internal housing inside the container and within the external magnetic field of the external magnet, wherein the internal plate comprises either a second magnet or a conductive plate;
an automated shaft connected to the external magnet and configured to rotate the external magnet and induce an electrical field and/or a magnetic field around the internal rotating device;
wherein the electrical field or the magnetic field moves the internal housing within the liquid;
a first baffle connected to the internal housing and exhibiting movement within the liquid with corresponding movement of the internal housing;
a second baffle connected to the first baffle and a second baffle support and exhibiting additional movement within the liquid with the corresponding movement of the internal housing;
a cap on the container, wherein the cap comprises an inner surface and an outer surface, wherein the inner surface of the cap comprises an edge that mates with the internal housing of the internal magnet; and
a bottom enclosure on the container, wherein the bottom enclosure comprises a respective inner surface that mates with the second baffle support.

12. The modular system of claim 11, wherein the internal housing is configured to mate with the bottom enclosure instead of the cap, and the second baffle support is configured to mate with the cap instead of the bottom enclosure.

13. The modular system of claim 11, further comprising at least one outlet for incoming and outgoing liquid relative to the container.

14. The modular system of claim 11, wherein the container, the inner housing, the first baffle, and the second baffle comprise a closed system that is mechanically isolated from the external magnet.

15. The modular system of claim 11, further comprising an electronic controller connected to the automated shaft to allow for power control in rotating the external magnet.

16. The modular system of claim 44, further comprising a motor connected to the automated shaft and in electrical communication with the controller.
